(19) United States
(12) Patent Application Publication
(10) Pub. No.: US 2010/0224272 A1
(43) Pub. Date: Sep. 9, 2010

(54) Circular Distributor for Thick Materials, in Particular for Liquid Concrete

(76) Inventors: Raimund Maeckle, Esslingen (DE); Karl-Heinz Junghans, Filderstadt (DE)

Correspondence Address: COLLARD & ROE, P.C., 1077 NORTHERN BOULEVARD, ROSLYN, NY, 11576, US

(21) Appl. No.: 12/225,324

(22) PCT Filed: Sep. 20, 2007
(86) PCT No.: PCT/EP2007/059950

§ 371 Date: Sep. 18, 2008

(30) Foreign Application Priority Data
Oct. 19, 2006 (DE) 10 2006 049 930.1

(51) Int. Cl. E04G 21/04; F16L 9/22; F16L 43/00

(52) U.S. Cl. 137/615; 138/155; 138/177

(57) ABSTRACT

The invention relates to a circular distributor for thick materials, in particular for liquid concrete. The circular distributor comprises a support frame (10) mounted on a base (16), a frame-secured conveying pipe (24) which can be charged at an inlet end (26) with thick materials under pressure, a first pipe bend (30) coupled to the outlet end of the frame-secured conveying pipe (24), a second pipe bend (34) which, via a first articulated coupling (32), can be pivoted with respect to the first pipe bend (30) about a vertical axis (36) of the support frame (10), and a distributor pipe (44) connected to the second pipe bend (34), the outlet end of which distributor pipe has an outlet opening (48) for the thick materials. According to the invention, a third pipe bend (40) is arranged between the second pipe bend (34) and the distributor pipe (44), this third pipe bend being able to pivot on the second pipe bend (34) via a second articulated coupling (38) having a horizontal axis (46) which is perpendicular to the vertical axis (36) and being coupled to the distributor pipe (44) via a connector coupling (42).

The invention relates to a circular distributor for thick substances, particularly for liquid concrete, having a support frame that can be set up on a base, having a conveyor pipe fixed in place on the frame, to which the thick substances can be applied under pressure, at an inlet-side end, having a first pipe bend connected to the outlet-side end of the conveyor pipe fixed in place on the frame, having a second pipe bend that can be pivoted relative to the first pipe bend, at a first articulation coupling, about a vertical axis of the support frame, and a distributor pipe connected with the second pipe bend, whose outlet-side end has an exit opening for the thick substances.

Circular distributors of the type stated are used for introducing concrete wherever direct distribution with concrete pump trucks and stationary distributor masts comes up against technical and economic limits. This is the case, for example, at construction sites on large areas and decks, which the distributor mast of a concrete pump truck cannot reach or cannot fully cover. The circular distributor is set up at the edge of or directly on the substratum to which concrete is to be applied, and liquid concrete is applied to it from a concrete pump, on the inlet side, by way of a hose or pipe connection. The distributor pipe and, if applicable, the conveyor pipe can be pivoted over the surface to which concrete is to be applied, maintaining a predetermined height of the exit opening of the distributor pipe, relative to a base of the support frame, in such a manner that even relatively large concrete application fields can be covered without gaps, with little physical effort. For use at the construction site, the conveyor lines are connected with pipe couplings, to meet the needs of the construction site. By moving the circular distributor with a construction crane, it is possible to open up concrete application fields of any desired size, whereby open up, whereby the feed line, i.e. the feed hose merely has to be lengthened or shortened. The small dimensions of the circular distributor in its transport position allow simple and space-saving transport on the loading frame of the concrete pump truck, on a truck, or on a trailer.

The circular distributor cannot easily be used for concrete application tasks where the introduction sites for the concrete lie higher or lower than the setup plane of the support frame, or vary in height. In such a case, attempts have already been made to make do with an additional mast arm, by way of which a conveyor pipe is guided all the way to an end hose, similar to the case of a distributor mast. However, this construction is structurally complicated and difficult to handle.

Proceeding from this, the invention is based on the task of developing a circular distributor of the type stated initially, which can overcome a certain height, along with large concrete-application areas, with its exit location, and nevertheless has a simple structure and is easy to handle.

To accomplish this task, the combinations of characteristics indicated in claims 1 and 18 are proposed. Advantageous embodiments and further developments of the invention are evident from the dependent claims.

The solution according to the invention is particularly based on the idea that the distributor pipe can be adjusted, with its exit opening, both over the plane defined by the base of the circular distributor and perpendicular to it, without an additional mast arm, so that introduction locations of different height can be reached with the exit opening of the distributor pipe. This is made possible, according to the invention, in that a third pipe bend is disposed between the second pipe bend and the distributor pipe, and is connected to the second pipe bend by way of a second articulation coupling, so as to pivot about a horizontal axis that is perpendicular to the vertical axis, and to the inlet-side end of the distributor pipe, by way of a rigid connection coupling, which can be configured as a muff coupling or as a welded connection, for example. In the region of the pipe bends situated between the conveyor pipe fixed in place on the frame and the distributor pipe, two pipe couplings configured as articulation couplings are therefore disposed, which allow pivoting of the distributor pipe about axes that are perpendicular to one another.

According to a preferred embodiment of the invention, the second articulation coupling spans a pivoting plane that is perpendicular to the horizontal axis, and intersects the pivoting plane of the first articulation coupling and the connection plane of the connection coupling to the distributor pipe in perpendicular manner, in each instance, and centrally in the region of the coupling, in each instance. For this purpose, it is advantageous if a straight pipe piece that is aligned with the outlet opening of the first and the inlet opening of the second pipe bend is disposed between the first and the second pipe bend, which piece is connected with one of the two pipe bends by way of the first articulation coupling, and is rigidly connected with the other pipe bend, for practical purposes. It is advantageous if the straight pipe piece is connected with the first pipe bend by way of the articulation coupling, and with the second pipe bend by way of a rigid connection coupling.

Another preferred embodiment of the invention provides that the entry opening of the second pipe bend and the exit opening of the third pipe bend span a plane that is perpendicular to the opening axis, in each instance, which plane is oriented perpendicular to the plane spanned through the second articulation coupling, between the second and third pipe bend. Accordingly, the plane spanned through the second articulation coupling, between the second and third pipe bend, intersects the entry opening of the first and the exit opening of the second pipe bend in the region of the center of the opening, in each instance. With reference to the pipe bend, this means that the second and the third pipe bend each have a connection opening and an articulation opening perpendicular to the former, whereby the articulation opening spans a plane that intersects the connection opening in the region of its center, in each instance.

In the case of the second pipe bend, a pipe elbow is disposed between the articulation opening and the connection opening, the center line of which elbow spans planes that are perpendicular to one another in an articulation-side section and in a connection-side section, and intersect the articulation opening and the connection opening in the center. In this connection, it is practical if the pipe bend is composed of a 135° pipe elbow that has the articulation opening, and a 90° pipe elbow that has the connection opening, and is rotated by 90° relative to the former.

In the case of the third pipe bend, a pipe elbow is disposed between the articulation opening and the connection opening, the center line of which runs in a plane that intersects the articulation opening and the connection opening in the center. For this purpose, the pipe bend in question can be composed of a 135° pipe elbow that has the articulation opening, and a 45° pipe elbow that has the connection opening, which lies in the same plane and runs in the opposite direction.

In order to fulfill the geometrical prerequisites indicated above, the two pipe elbows can be connected with one another by means of a straight pipe piece, in each instance. Furthermore, the 135° pipe elbow can be composed of a 90° pipe elbow and a 45° pipe elbow, for example by means of welding.

In order to be able to adjust the distributor pipe in a predetermined height of its exit opening, relative to the support frame, it is advantageous if a bearing journal is provided, disposed fixed on the frame, at an axial distance from the first articulation coupling, aligned with the vertical axis in the region of the first articulation coupling, and a holder is provided, disposed on the distributor pipe at a distance from the second articulation coupling. Furthermore, a bracing element is provided, fixed in place on the holder with its one end, and mounted on the bearing journal with its other end, so as to pivot about the vertical axis in question, preferably configured as a chain or cable element or as a hydraulic piston/cylinder unit, which can be adjusted, in terms of its bracing length, raising or lowering the exit opening. In this connection, the bracing element and the distributor pipe span a plane that aligns with the parting plane of the second articulation coupling.

In order to increase the pivoting range of the circular distributor, it is proposed, according to a preferred embodiment of the invention, that the support frame has a boom that carries the conveyor pipe, disposed to rotate about a vertical axis on the substructure, and that the entry-side end of the conveyor pipe is connected with a charging pipe fixed in place on the substructure, by way of a central rotating pass-through. Furthermore, the pipe bends that are intended for use in a circular distributor for thick substances, and have a connection opening disposed at one end and an articulation opening disposed at the other end, perpendicular to the former, whereby according to the invention, the articulation opening spans a plane that intersects the plane of the connection opening in the region of the center of the opening, are an object of the invention. It is advantageous if, in the case of one of the two pipe bends, a pipe elbow is disposed between the articulation opening and the connection opening, the center line of which elbow is disposed in a plane that intersects the articulation opening and the connection opening in the center. In the case of a second pipe bend, a pipe elbow whose center line spans two planes that are perpendicular to one another, in a first section and in a second section, which intersect the articulation opening and the connection opening in the center, is disposed between the articulation opening and the connection opening.

In the following, the invention will be explained in greater detail using exemplary embodiments shown schematically in the drawing. This shows:

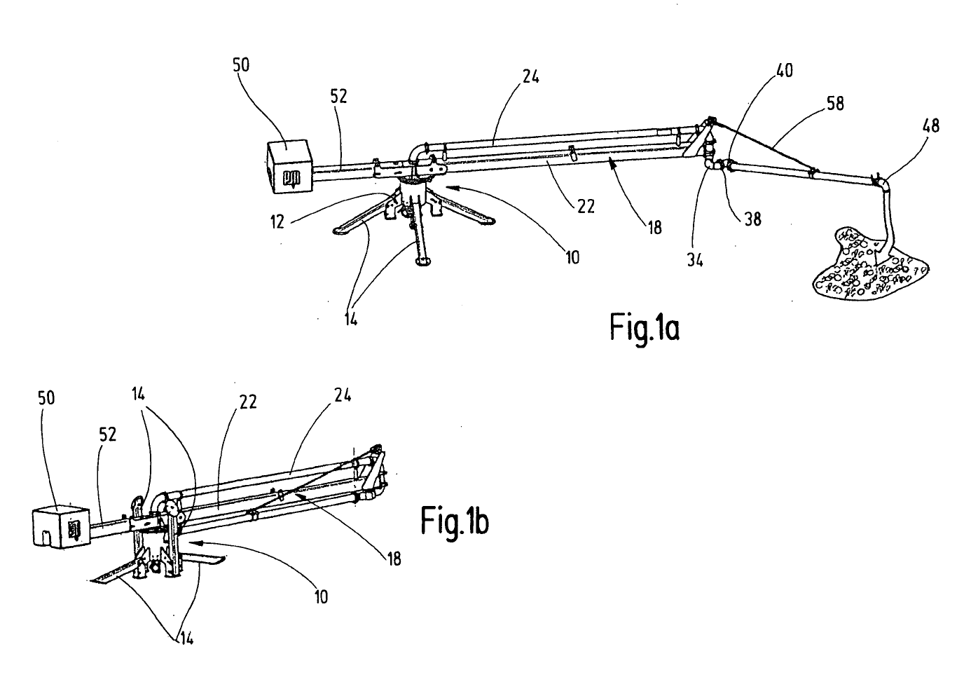

FIG. 1a a circular distributor having a distributor pipe that can be raised and lowered, in a diagrammatic representation, in a working position when applying concrete to horizontal surfaces;

FIG. 1b the circular distributor according to FIG. 1 in a diagrammatic representation in the folded-in transport position;

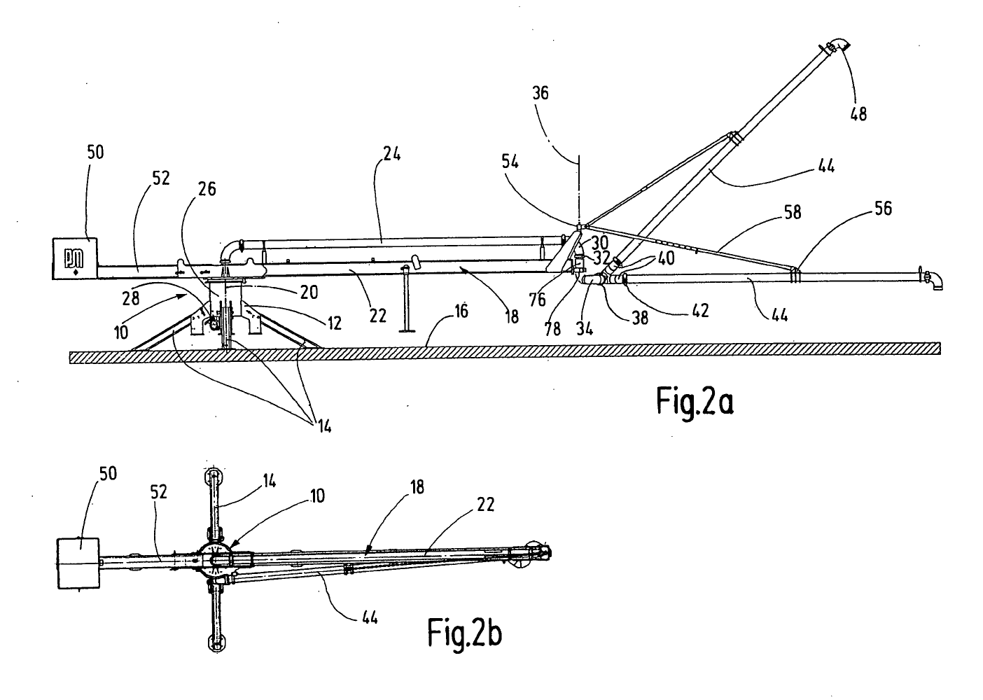

FIG. 2a a side view of the concrete distributor according to FIG. 1a in the working position, with two different orientations of the distributor pipe;

FIG. 2b a top view of the circular distributor, with the distributor pipe pivoted in;

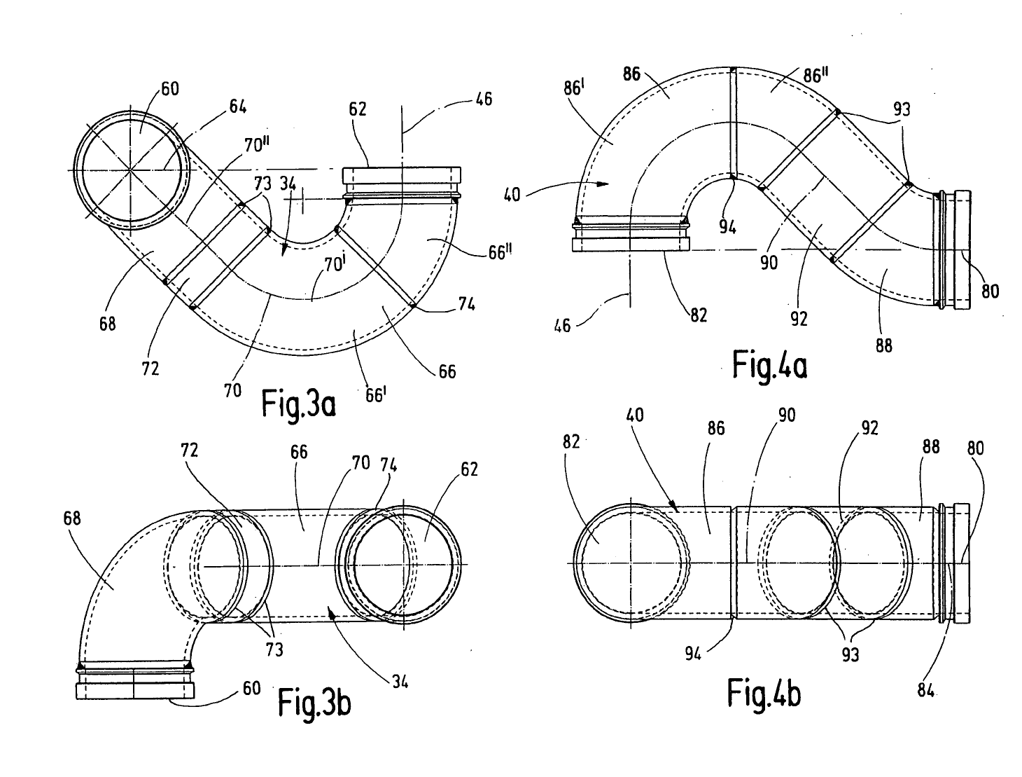

FIGS. 3a and b two side views of the second pipe bend of the circular distributor according to FIGS. 1 and 2;

FIGS. 4a and b two side views of the third pipe bend of the circular distributor according to FIGS. 1 and 2.

The circular distributor shown in the drawing serves to introduce liquid concrete at construction sites, where direct distribution with concrete pump trucks and stationary distributor masts comes up against technical and economic limits. The circular distributor can overcome not only large concrete application areas, but also a certain height, large concrete application areas, but also a certain height, with its exit location, and nevertheless has a simple structure and is easy to handle.

The circular distributor shown in FIGS. 1 and 2 has a support frame 10, the substructure 12 of which can be set up on a base 16 with four pivot legs 14 disposed in star shape. As can be seen in FIG. 1b, the four pivot legs 14 can be folded up and to the side, in pairs, so that the circular distributor can be transported on a truck or in a container, in space-saving manner, without disassembly.

A two-arm boom 18 is mounted on the substructure 12 of the support frame 10, so as to rotate by 360° about a vertical axis 20. The boom 18 carries a conveyor pipe 24 on its one arm 22, which pipe passes through, on the entry side, to a charging connector 28 fixed in place on the substructure, by way of a rotating pass-through 26, and is guided to a first 90° pipe bend 30 disposed at the tip of the boom arm 22, by way of the arm. A second pipe bend 34 follows the first pipe bend 30, by way of a first articulation coupling 32, and can be pivoted relative to the first pipe bend 30, about an articulation axis configured as a vertical axis 36, by way of the first articulation coupling 32. As is particularly evident from FIG. 2a, a pipe piece 76 that is aligned with the outlet opening of the first pipe bend 30 and the inlet opening 60 of the second pipe bend 34 is disposed between the first and the second pipe bend 30, 34. The pipe piece 76 is connected with the first pipe bend 30 by way of the first articulation coupling 32, and rigidly connected with the second pipe bend 34 by means of a connection coupling 78. All the articulation and connection couplings are configured as muff couplings.

On the exit side, the second pipe bend 34 is connected, by way of a second articulation coupling 38, with a third pipe bend 40, which is connected, on the exit side, to align with a distributor pipe 44, by way of a rigid connection coupling 42 configured as a muff coupling or as a welded connection. The third pipe bend 40, together with the distributor pipe 44, can be pivoted about a horizontal axis 46 that is perpendicular to the vertical axis 36, in the region of the second articulation coupling 38, raising and lowering the exit opening 48 of the distributor pipe 44 (cf. FIG. 2a). A counter-weight 50 on the second boom arm 52, which can be composed of multiple individual weights, ensures instantaneous equalization of the boom in the region of its support on the substructure 17.

On the free end of the first boom arm 22, the boom 18 has a bearing journal 54 disposed at an axial distance from the first articulation coupling 32, while a holder 56 is disposed on the distributor pipe 44, at a distance from the second articulation coupling 38. A bracing element configured as a chain element or as a hydraulic cylinder/piston unit 58 is tensioned between the bearing journal 54 and the holder 56, and can be lengthened or shortened, adjusting the work angle of the distributor pipe 44. At its rear end, the bracing element 58 is mounted on the bearing journal 54 with a bearing sleeve 60, to rotate about the vertical axis that runs through the articulation coupling 32. In this manner, the distributor pipe 44 with its exit opening 48, can be rotated about the vertical axis 36 of the first articulation coupling 32, from the position shown in FIG. 2a, to the position shown in FIG. 2b, even in its raised position, without changing the height of the exit opening 48.

Pivoting of the distributor pipe 44 about two articulation axes 36 and 46, which are perpendicular to one another, in the region of the tip of the boom arm 22, is made possible by means of a special shaping of the second and third pipe bend (FIGS. 3a and b and FIGS. 4a and b).

The second pipe bend 34 has a connection opening 60 and an articulation opening 62, perpendicular to the latter, whereby the articulation opening 62 spans a plane 64 that intersects the connection opening 60 in the region of its center. A pipe elbow group 66, 68, the center line 70 of which spans planes that lie perpendicular to one another and intersect the articulation opening 62 and the connection opening 60 in the center, in an articulation-side section 70′ and a connection-side section 70″, is situated between the articulation opening 62 and the connection opening 60 of the second pipe bend 34. In this connection, the pipe bend 34 is composed of a 135° elbow 66 that has the articulation opening 62, and a 90° pipe elbow 68 that has the connection opening 60, and is rotated by 90° relative to the former, whereby the two pipe elbows 66, 68 are connected with one another by means of a straight pipe piece 72, at weld seams 73. As is particularly evident from FIG. 3a, the 135° pipe elbow 66 is composed of a 90° pipe elbow 66′ and a 45° pipe elbow 66″, at a weld seam.

According to FIGS. 4a and b, the third pipe elbow 40 has a connection opening 80 and an articulation opening 82 perpendicular to the latter, whereby the articulation opening 82 spans a plane 84 that intersects the connection opening 80 in the region of its center. A pipe elbow group 86, 88, the center line of which runs in a plane that intersects the articulation opening 82 and the connection opening 80 in the center, is situated between the articulation opening 82 and the connection opening 80 of the third pipe bend 40. In this connection, the third pipe bend 40 is composed of a 135° pipe elbow 86 that has the articulation opening 82, and a 45° pipe elbow that has the connection opening 80, lies in the same plane, and runs in the opposite direction. The two pipe elbows 86, 88 are connected with one another by means of a straight pipe piece 92, at weld seams 93. The 135° pipe elbow 86 is composed of a 90° pipe elbow 86′ and a 45° pipe elbow 86″, at a weld seam 94.

In summary, the following should be stated: The invention relates to a circular distributor for thick substances, particularly for liquid concrete. The circular distributor comprises a support frame 10 that is set up on a base 16, a conveyor pipe 24 fixed in place on the frame, to which thick substances can be applied under pressure, at an inlet-side end 26, a first pipe bend 30 connected to the outlet-side end of the conveyor pipe 24 fixed in place on the frame, a second pipe bend 34 that can be pivoted relative to the first pipe bend 30, at a first articulation coupling 32, about a vertical axis 36 of the support frame 10, and a distributor pipe 44 connected with the second pipe bend 34, whose outlet-side end has an exit opening 48 for the thick substances. According to the invention, a third pipe bend 40 is disposed between the second pipe bend 34 and the distributor pipe 44, and is connected to the second pipe bend 34 by way of a second articulation coupling 38, so as to pivot about a horizontal axis 46 that is perpendicular to the vertical axis 36, and to the distributor pipe 44, by way of a connection coupling 42.

1. Circular distributor for thick substances, particularly for liquid concrete, having a support frame (10) that can be set up on a base (16), having a conveyor pipe (24) fixed in place on the frame, to which the thick substances can be applied under pressure, at an inlet-side end (26), having a first pipe bend (30) connected to the outlet-side end of the conveyor pipe (24) fixed in place on the frame, having a second pipe bend (34) that can be pivoted relative to the first pipe bend (30), at a first articulation coupling (32), about a vertical axis (36) of the support frame (10), and a distributor pipe (44) connected with the second pipe bend (34), whose outlet-side end has an exit opening (48) for the thick substances, wherein a third pipe bend (40) is disposed between the second pipe bend (34) and the distributor pipe (44), and is connected to the second pipe bend (34) by way of a second articulation coupling (38), so as to pivot about a horizontal axis (46) that is perpendicular to the vertical axis (36), and to the inlet-side end of the distributor pipe (44), by way of a connection coupling (42).

2. Circular distributor according to claim 1, wherein the connection coupling (42) is configured as a weld connection between the third pipe bend (40) and the distributor pipe (44).

3. Circular distributor according to claim 1, wherein the second articulation coupling (38) spans a plane (64) that is perpendicular to the horizontal axis (46), and intersects the plane of the first articulation coupling (32) and the plane of the connection coupling (42) in perpendicular and centered manner, in each instance, in the region of the coupling, in each instance.

4. Circular distributor according to claim 1, wherein a straight pipe piece (76) aligned with the outlet opening of the first pipe bend (30) and the connection opening (60) of the second pipe bend (34) is disposed between the first and the second pipe bend (30, 34), which piece is connected with one of the two pipe bends (30) by way of the first articulation coupling (32).

5. Circular distributor according to claim 4, wherein the straight pipe piece (76) is connected with the second pipe bend (34), so as to rotate or rigidly.

6. Circular distributor according to claim 4, wherein the straight pipe piece (76) is connected with the first pipe bend (30) by way of the first articulation coupling (32), and with the second pipe bend (34) by way of a rigid connection coupling (78).

7. Circular distributor according to claim 1, wherein the second and the third pipe bend (30, 34) each have a connection opening (60, 80) and an articulation opening (62, 82) perpendicular to the latter, whereby the articulation opening (62, 82) spans a plane that intersects the connection opening (60, 80) in the region of its center, in each instance.

8. Circular distributor according to claim 7, wherein a pipe elbow group (86, 88) is disposed between the articulation opening (82) and the connection opening (80) of the third pipe bend (46), the center line (90) of which runs in a plane that intersects the articulation opening (82) and the connection opening (80) in the center.

9. Circular distributor according to claim 7, wherein the connection opening (60) of the second pipe bend (34) and the connection opening (80) of the third pipe bend (40) each span a plane that is oriented perpendicular to the plane spanned through the second articulation coupling (38), between the second and third pipe bend (30, 34).

10. Circular distributor according to claim 7, wherein the plane spanned through the second articulation coupling (38), between the second and third pipe bend (30, 34), intersects the connection opening (60) of the second pipe bend (34) and the connection opening (80) of the third pipe bend (40), in the region of the opening center, in each instance.

11. Circular distributor according to claim 7, wherein the third pipe bend (40) is composed of a 135° pipe elbow (86) that has the articulation opening (82), and a 45° pipe elbow (88) that has the connection opening (80), which lies in the same plane and runs in the opposite direction.

12. Circular distributor according to claim 7, wherein a pipe elbow group (66, 68), the center line (70) of which spans planes that lie perpendicular to one another and intersect the articulation opening (62) and the connection opening (60) in the center, in an articulation-side section (70′) and a connection-side section (70″), is situated between the articulation opening (62) and the connection opening (60) of the second pipe bend (34).

13. Circular distributor according to claim 7, wherein the second pipe bend (34) is composed of a 135° pipe elbow (66) that has the articulation opening (62), and a 90° pipe elbow (68) that has the connection opening (60), and is rotated by 90° relative to the former.

14. Circular distributor according to claim 7, wherein the two pipe elbows (66, 68, 86, 88) are connected with one another by means of a straight pipe piece (72, 92).

15. Circular distributor according to claim 11, wherein the 135° pipe elbow (86) is composed of a 90° pipe elbow and a 45° pipe elbow (86′, 86″).

16. Circular distributor according to claim 1, further comprising a bearing journal (54) disposed at an axial distance from the first articulation coupling (32), disposed fixed on the frame, aligned with the vertical axis (36) in the region of the first articulation coupling (32), a holder (56) disposed on the distributor pipe (44), at a distance from the second articulation coupling (38), and a bracing element (58) fixed in place on the holder (56) with its one end, and mounted on the bearing journal (54) with its other end, so as to pivot about the vertical axis (36), which element can be adjusted in terms of its tensioning length.

17. Circular distributor according to claim 16, wherein the bracing element (58) is configured as a hydraulic cylinder/piston unit or as a chain or cable element.

18. Circular distributor according to claim 17, wherein the bracing element (58) and the distributor pipe (44) span a plane that aligns with the plane of the second articulation coupling (38).

19. Circular distributor according to claim 1, wherein the support frame (10) has a boom (18) that carries the conveyor pipe (24), disposed to rotate about a vertical axis (20) on the substructure (12), and wherein the entry-side end of the conveyor pipe (24) is connected with a charging pipe (28) fixed in place on the substructure, by way of a central rotating pass-through (26).

20. Pipe bend for use in a circular distributor for thick substances, having a connection opening (60, 80) disposed at one end, and an articulation opening (62, 82) disposed at the other end, perpendicular to the former, wherein the articulation opening (62, 82) spans a plane that intersects the plane of the connection opening (60, 80) in the region of the center of the opening.

21. Pipe bend according to claim 20, wherein a pipe elbow group (86, 88) is disposed between the articulation opening (82) and the connection opening (80), the center line (90) of which is disposed in a plane (84) that intersects the articulation opening (82) and the connection opening (80) in the center.

22. Pipe bend according to claim 20, further comprising a 135° pipe elbow (86) that has the articulation opening (82), and a 45° pipe elbow (88) that has the connection opening (80), and runs in the opposite direction.

23. Pipe bend according to claim 20, wherein a pipe elbow group (66, 68) is disposed between the articulation opening (62) and the connection opening (60), the center line (70) of which spans two planes that are perpendicular to one another and intersect the articulation opening (62) and the connection opening (60) in the center, in a first section (70″) and a second section (70′).

24. Pipe bend according to claim 20, further comprising a 135° pipe elbow (66) that has the articulation opening (62), and a 90° pipe elbow (68) that has the connection opening (60), and is rotated by 90° relative to the former.

25. Pipe bend according to one claim 22, wherein the two pipe elbows (66, 68; 86, 88) are connected with one another by means of a straight pipe piece (72, 92).

26. Pipe bend according to claim 22, wherein the 135° pipe elbow (66, 86) is composed of a 90° pipe elbow and a 45° pipe elbow (66′, 66″; 86′ 86″).
